(19) United States
(12) Patent Application Publication
(10) Pub. No.: US 2026/0008709 A1
(43) Pub. Date: Jan. 8, 2026

(54) BATCH DELIVERY SYSTEM FOR GLASS MANUFACTURING

(71) Applicant: Owens-Brockway Glass Container Inc., Perrysburg, OH (US)

(72) Inventors: Kirk Holmes, Perrysburg, OH (US); Steven Will, Sylvania, OH (US)

(21) Appl. No.: 19/258,824

(22) Filed: Jul. 2, 2025

Related U.S. Application Data
(60) Provisional application No. 63/667,125, filed on Jul. 2, 2024.

(51) Int. Cl. C03B 3/00; C03B 5/173; C03B 5/24

(52) U.S. Cl. CPC C03B 3/00; C03B 5/173; C03B 5/24

(57) ABSTRACT

A batch delivery system is disclosed that includes a shared batch distribution unit and at least one companion batch distribution unit. The shared batch distribution unit supplies a partial batch material to the companion batch distribution unit. A counterpart batch material is added to the partial batch material at the companion batch distribution unit to form a batch feed material that is ultimately delivered to a glass production line for melting. A glass manufacturing plant that includes the batch delivery system and related methods are also disclosed.

### BACKGROUND

The commercial scale manufacture of glass articles requires a vitrifiable mixture of raw materials, often referred to as a “batch feed material,” to be melted into molten glass. The various raw materials of the batch feed material and their relative proportions therein are managed to produce glass with the desired chemistry. For soda-lime-silica glass, for example, the batch feed material typically includes sand, soda ash, and limestone as a source of SiO₂, Na₂O, and CaO in the glass, respectively, and may additionally include recycled glass (i.e., cullet) to reduce the necessary content of other raw materials in the batch feed material and to help improve melting efficiency since cullet is essentially previously-formed glass that has already undergone the glass melting reactions. These raw materials—that is, sand, soda ash, limestone, and cullet—are considered the “major” raw materials of the batch feed material since together they constitute most of the batch feed material by weight. The batch feed material may also include one or more “minor” raw materials. A minor raw material is any material included in the batch feed material that is not one of the major raw materials. A broad variety of materials may be included in the batch feed material as the minor raw material(s) including various glass stabilizers, fluxes, network formers, network modifiers, colorants, and other materials that may be used to affect the composition and/or properties of the glass.

In a conventional glass manufacturing plant that includes one or more continuous melting furnaces to melt the batch feed material into molten glass, the batch feed material has traditionally been stored in a “batch house.” The batch house is usually constructed adjacent to a building that houses the continuous glass melting furnace(s) to help make the transfer of the batch feed material to the furnace(s) as easy as possible. A continuous melting furnace is a large, refractory structure that employs overhead (non-submerged) burners to radiantly heat a relatively calm molten glass bath that flows slowly through the furnace over the course of an eighteen hour or longer residence time. This type of furnace is designed to operate continuously due to the large amount of glass it holds and the fact that the refractory structure of the furnace cannot easily be cooled down from the elevated temperatures associated with glass melting without suffering damage caused by thermal shock and/or other mechanisms. On account of the continuous operating nature of the furnace(s) and the comparative size of the batch house and the furnace(s) it supports, the batch house has proven to be an adequate solution for storing batch feed material within a conventional glass manufacturing plant.

The batch house is an imposing installation that includes a raw material unloading platform, large multi-story silos that separately store sand, soda ash, and limestone, and ground-level cullet pads where cullet is dumped and maintained until needed. The silos are serviced by bucket elevators and input conveyors that operate to move their respective raw materials from an underground unloading pit where the raw materials are initially unloaded to the tops of the silos where the raw materials are introduced into the silos for storage. The batch house additionally includes at least one batch mixer that receives the individual raw materials from their respective silos and a system of feeders, weigh scales, and output conveyors that deliver the correct quantities of the raw materials to the mixer. Any minor raw materials that need to be included in the batch feed material are also delivered to the mixer at the correct quantities from smaller tanks or bins located elsewhere within the batch house. The mixer mixes the various raw materials together and provides the batch feed material to an associated mixer conveyor that delivers the batch feed material out of the batch house for melting in a furnace. If cullet is added to the batch feed material, the cullet, which may be crushed on-site and delivered to a cullet silo, is added into the batch mixer with the other raw materials or is added to the batch feed material on the mixer conveyor. The batch house may additionally include other ancillary equipment such as a dust collection system.

Due to its multiple large silos, common structure such as the underground unloading pit and accompanying platform, and the structural foundation of the overall installation and supporting steel framework, the batch house is constructed to support the maximum conceivable glass capacity of the on-site continuous melting furnace(s). This is especially true since there is no practical and economical way to increase the maximum output capacity of batch feed material from the batch house after the batch house has been initially constructed. Indeed, the expansion or scaling up of the batch house to increase its output capacity of the batch feed material to support, for example, a new furnace that is added to the glass manufacturing site to serve new or additional market demand for glass, would necessitate major construction work including excavation, a new or enlarged concrete foundation along with accompanying steel framework, expansion of current structures within the batch house, and process integration, as well as the engineering, site preparation, and utility upgrades needed to customize the expansion. Such an investment in capital resources, labor, and plant downtime renders the expansion of a batch house largely untenable from a cost-benefit standpoint. In those instances where additional batch feed material is needed, it is oftentimes more economical to build an entirely new batch house than to expand an old one.

Submerged combustion melting is an alternative and relatively newer glass melting technique that employs submerged burners to discharge combustion products directly into a glass melt contained within a submerged combustion melter. The discharge of combustion products directly into the glass melt heats and vigorously agitates the glass melt, which enhances mixing of the batch feed material into the glass melt and causes more rapid heat transfer and particle dissolution throughout the glass melt compared to the slower melting kinetics that occur in a continuous melting furnace. As such, the residence time of glass in a submerged combustion melter is less—sometimes quite substantially—than what is customary for a continuous melting furnace. The shorter residence time of a submerged combustion melter allows the melter to occupy a smaller footprint and to contain less glass while still maintaining an acceptable glass output. And, as a result of its relatively reduced size, the submerged combustion melter can be fluid-cooled, thus providing the melter with the ability to be repeatedly shut down and restarted, and even disassembled and relocated, since the fluid-cooled melter does not have to survive the same type of extreme temperature change when being shut down that a continuous melting furnace would have to endure.

The smaller size and operational flexibility (e.g., on/off capability) of a submerged combustion melter has caused the way in which the batch feed material is stored and ultimately delivered to the melter to be reimagined. For example, a glass manufacturing plant may be constructed with infrastructure to add additional submerged combustion melters when additional glass capacity is needed, and to shut down, disassemble, and remove submerged combustion melters when the glass capacity of the plant needs to be reduced. As another example, a glass manufacturing plant with one or more submerged combustion melters may be designed to fit and operate fully or partially in a light industrial setting as opposed to the heavy industrial setting that typifies large factories and traditional glass manufacturing plants that include one or more continuous melting furnaces. In these examples, as well as others, a traditional batch house may not be workable. The batch house may simply be too large of a structure and/or its full scale construction and operation may not align with the vision of a flexible and adaptable glass manufacturing plant since the batch house cannot be feasibly constructed or deconstructed in stages to match the batch feed material needs of however many submerged combustion melters may be operating at a given time.

### SUMMARY

A batch delivery system is disclosed that is adapted to deliver a batch feed material to one or more submerged combustion melters within a glass manufacturing plant. The batch delivery system includes a shared batch distribution unit and at least one companion batch distribution unit. The shared batch distribution unit supplies a partial batch material, which is a portion of the batch feed material that is ultimately delivered to, and melted in, a submerged combustion melter. The partial batch material includes at least two major raw materials of the batch feed material. For example, the partial batch material may include soda ash and limestone, and may further include one or more minor raw materials such as a sulfate-containing material, an alumina-containing material, carbon, and/or a colorant. The shared batch distribution unit includes a container for each of the raw materials included in the partial batch material. Each of the raw materials included in the partial batch material is collected, preferably in a collection hopper, and the partial batch material is then delivered from the shared batch distribution unit to the companion batch distribution unit. In a preferred implementation, the collection hopper is carried on, and transported by, an automated guided vehicle, and once filled with the partial batch material, the collection hopper is delivered to a lifting and sending station. At the lifting and sending station, the collection hopper is retrieved, emptied into a pneumatic sender, and the partial batch material is delivered from the shared batch distribution unit by pneumatically conveying the partial batch material from the pneumatic sender.

The companion batch distribution unit of the batch delivery system is dedicated to at least one submerged combustion melter and delivers the batch feed material for melting in its associated melter(s). Each of the companion batch distribution units receives a partial batch material from the shared batch distribution unit, adds a counterpart batch material to the partial batch material to form the batch feed material, and delivers the batch feed material for melting. The counterpart batch material added at the companion batch distribution unit is also a portion of the batch feed material and includes at least one major raw material of the batch feed material. For example, if the partial batch material includes soda ash and limestone, as stated above, the counterpart batch material may include sand as well as one or more minor raw materials such as filter dust. Cullet may be added to the batch feed material at the companion batch distribution unit as well. In a preferred implementation, the companion batch distribution unit includes a pneumatic receiver that receives the partial batch material from the shared batch distribution unit. The partial batch material and the counterpart batch material are introduced into a mixer within the companion batch distribution unit to form the batch feed material and, thereafter, the batch feed material is discharged onto a batch conveyor, which delivers the batch feed material to melter day bin. The batch feed material is supplied from the melter day bin to a batch charger of the submerged combustion melter.

The batch delivery system can be deployed quickly and is able to be scaled up or down at any time to meet the glass capacity of the glass manufacturing plant. Initially, for example, the batch delivery system may include the shared batch distribution unit and a first companion batch distribution unit to supply the batch feed material to a first glass production line that includes a first submerged combustion melter. Then, in the future, a second companion batch distribution unit may be incorporated into the batch delivery system if a second glass production line having a second submerged combustion melter is added to the glass manufacturing plant, and so on. By having flexibility to add or remove companion batch distribution units to the batch delivery system, the output capacity of batch delivery system can be adjusted incrementally to meet the changing glass capacity of the plant without a prohibitive investment in time, workforce labor, and financial resources. This is especially true if the counterpart batch material that is added to the partial batch material at the companion batch distribution units includes sand. Specifically, since sand is the largest component of the batch feed material by weight, including sand in the counterpart batch material allows the shared batch distribution unit to achieve the throughput needed to serve multiple companion batch distribution units while occupying a relatively small footprint and, furthermore, defers construction of additional companion batch distribution units and the related capital investment until such time that the additional units are actually needed to serve new submerged combustion melters.

The batch delivery system can also render the glass manufacturing plant more operationally flexible by allowing different glass production lines to receive different batch feed materials if desired. For example, the respective batch feed materials delivered by the batch delivery system can be different on account of batch composition and/or mass flow rate. In one operating scenario, the shared batch distribution unit in combination with two companion batch distribution units may deliver a batch feed material corresponding to one color of glass to one glass production line and another batch feed material corresponding to another color of glass to another glass production line. Such a change in batch composition of the batch feed materials fed to the two different glass production lines can be achieved, for example, by adding or not adding a colorant to the partial batch materials delivered to the companion batch distribution units associated with the glass production lines. In another operating scenario, in which one of two glass production lines requires more or less batch feed material due to different glass production rates or a difference glass articles being produced, the shared batch distribution unit in combination with two companion batch distribution units may deliver a batch feed material at one flow rate to one glass production line and a batch feed material at another flow rate to the another glass production line.

### BRIEF DESCRIPTION OF THE DRAWINGS

FIG. 1 is a schematic plan view of a glass manufacturing plant that includes one glass production line, which includes a submerged combustion melter, and a batch delivery system according to one embodiment of the present disclosure;

FIG. 2 is a schematic plan view of the shared batch distribution unit of the batch delivery system shown in FIG. 1;

FIG. 3 is a schematic side elevational view of the shared batch distribution unit shown in FIGS. 1 and 2;

FIG. 4 is a schematic plan view of the companion batch distribution unit of the batch delivery system shown in FIG. 1;

FIG. 5 is a schematic side elevational view of the companion batch distribution unit shown in FIGS. 1 and 2;

FIG. 6 is a schematic plan view of a glass manufacturing plant that includes a plurality of glass production lines, each of which includes a submerged combustion melter, and a batch delivery system according to another embodiment of the present disclosure;

FIG. 7 is a schematic plan view of the shared batch distribution unit of the batch delivery system shown in FIG. 6;

FIG. 8 is a schematic side elevational view of the shared batch distribution unit shown in FIGS. 6 and 7; and

FIG. 9 is a schematic side elevational view representative of a portion of each of the first, second, and third companion batch distribution units shown in FIG. 6.

### DETAILED DESCRIPTION

A batch delivery system is disclosed that is part of a glass manufacturing plant. The batch delivery system stores individual raw materials for glass manufacturing and supplies a batch feed material to the melting operations of the plant. The batch feed material, in particular, is a combination of a plurality of the raw materials and is formulated to produce, upon melting, molten glass of a certain composition or chemistry such as, for example, soda-lime-silica glass of any of a variety of colors including flint, green, amber, and blue. The batch delivery system includes a shared batch distribution unit and one or more companion batch distribution units. The shared batch distribution unit delivers a partial batch material, which includes at least two major raw materials of the batch feed material, to each of the companion batch distribution units. At each of the companion batch distribution units, a counterpart batch material that includes at least one major raw material is added to the received partial batch material to form the batch feed material. The batch feed material is then delivered from each of the companion batch distribution units to at least one glass production line and, more specifically, to a submerged combustion melter of the at least one glass production line. The batch delivery system can be easily scaled up by adding and/or activating one or more companion batch distribution units to increase its output capacity, and can easily be scaled down by removing and/or deactivating one or more companion batch distribution units to decrease its output capacity.

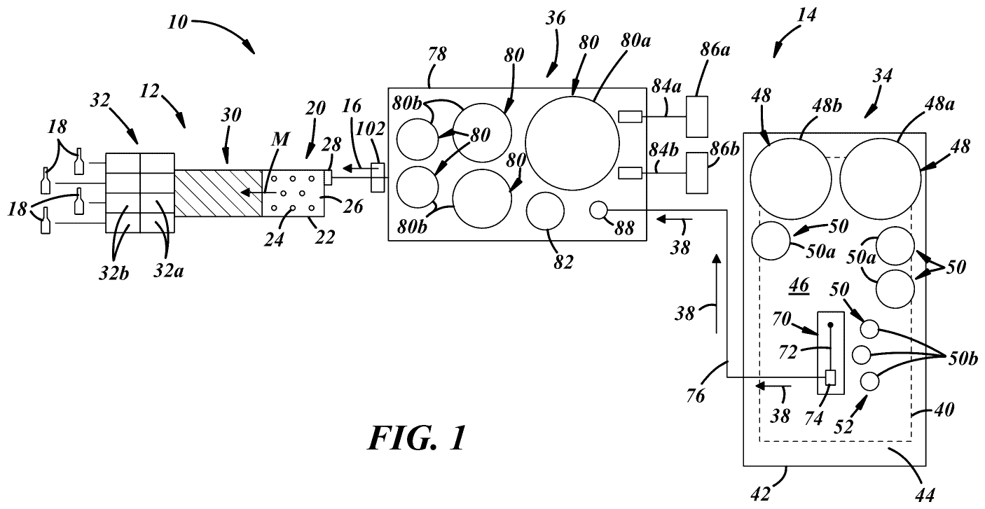

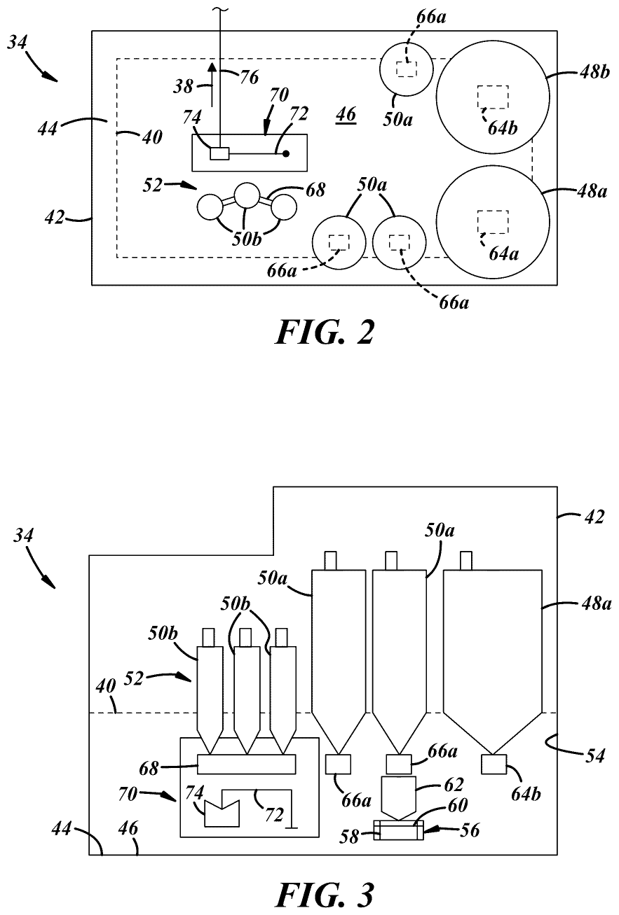

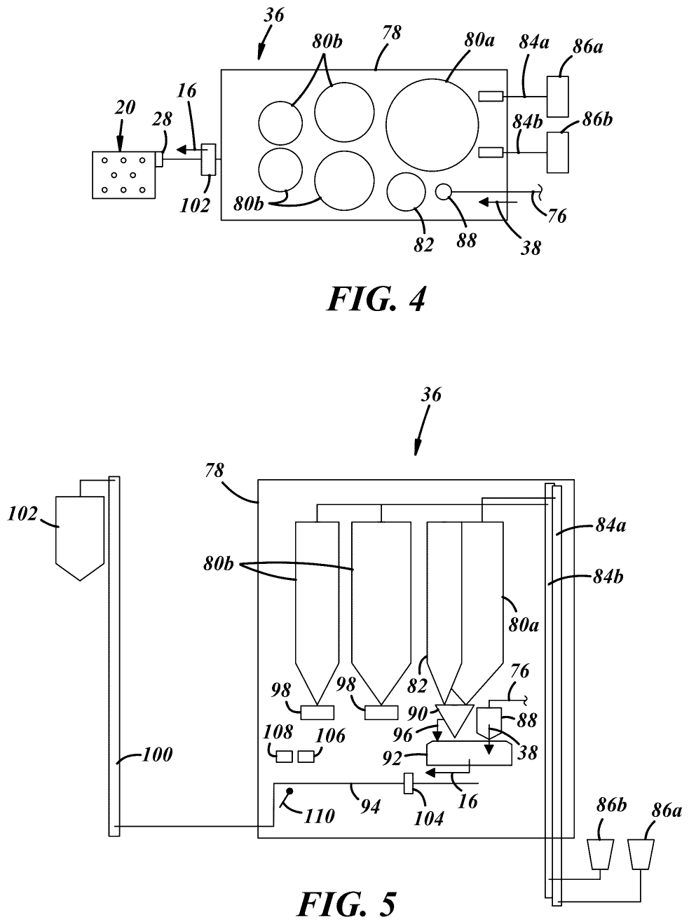

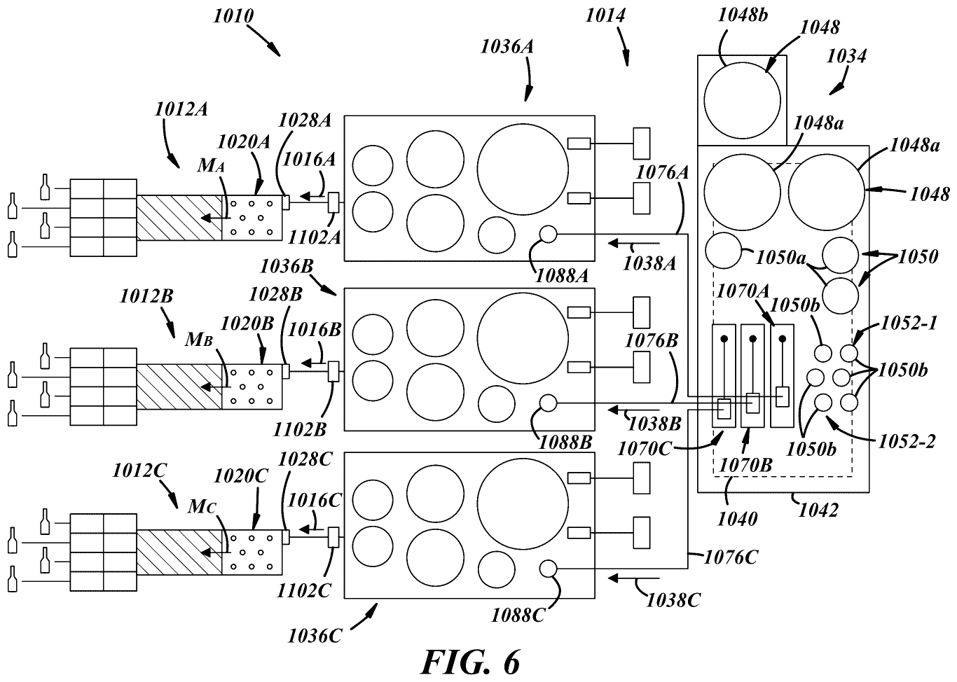

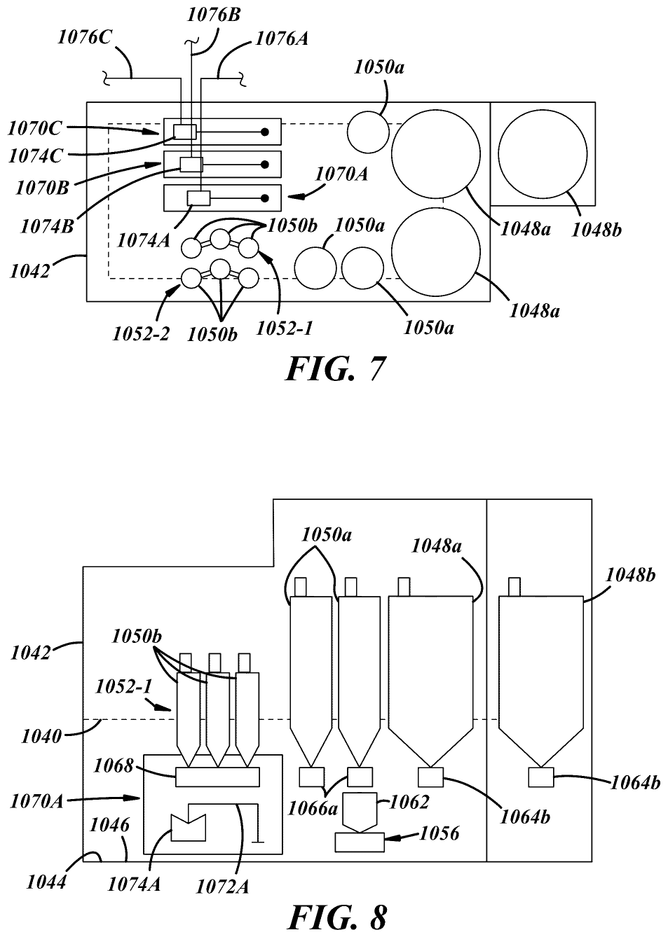

Referring now to FIGS. 1-5, a glass manufacturing plant 10 is depicted that includes a glass production line 12 and a batch delivery system 14 that delivers a batch feed material 16 to the glass production line 12. The glass production line 12 receives the batch feed material 16 from the batch delivery system 14, melts the batch feed material 16 and produces molten glass M, and forms glass containers 18 from the molten glass M. Here, in this implementation of the plant 10, the glass production line 12 is the only operating glass production line and, thus, the glass capacity of the plant 10 is established by the glass production line 12. The glass capacity may be expressed in the maximum weight of molten glass M that can be produced by the plant 10 per unit of time such as, for example, in tons (1 ton=2000 lb) per day or in any other appropriate metric. In another implementation, for example, and as shown in FIGS. 6-8 and described in more detail below, the glass manufacturing plant 1010 may include more than one glass production line 1012 and, in that scenario, the glass capacity of the plant 10 is established by the multiple operating glass production lines 1012. The batch delivery system 14 is configurable to service one glass production line 12 or a plurality of glass production lines 12 and can be transitioned between those operating states to help coordinate the output capacity of the batch delivery system 14 with the glass capacity of the glass manufacturing plant 10.

The glass production line 12 includes a submerged combustion melter 20 to melt the batch feed material 16 and produce the molten glass M from the melted batch feed material. The submerged combustion melter 20 includes a tank 22 and one or more submerged burners 24 received in the tank 22. The submerged burners 24, which are preferably received in a floor 26 of the tank 22, include burner tips that are submerged by a glass melt that is contained within the tank 22. As such, the submerged burners 24 are configured to discharge the combustion products of a combustion reaction between a fuel and an oxidant directly into the glass melt—as opposed to being discharged into an open combustion zone about the glass—such that the combustion products heat and agitate the glass melt as they are fired through the glass melt. The batch feed material 16 is introduced into the glass melt and, over time, melts within and becomes incorporated into the glass melt. The batch feed material 16 may be introduced into glass melt through a batch inlet, which is defined by the tank 22, by a batch charger 28 that is appended to the tank 22 and is part of the submerged combustion melter 20. The batch charger 28 may include a feeder, such as a screw feeder, which is able to controllably introduce a measured amount of the batch feed material 16 into the submerged combustion melter 20 and may additionally include a chopper to help ensure that the inlet to the tank 22 does not become blocked. Some examples of suitable choppers are disclosed in U.S. Pat. No. 11,084,749 and International Pub. No. WO2024/258718.

The molten glass M is drawn out of the submerged combustion melter 20 from the glass melt and is typically drawn from a portion of the glass melt that has achieved the appropriate residence time within the melter 20. The submerged combustion melter 20 is preferably sized to produce between 50 tons/day and 150 tons/day of the molten glass M. After emerging from the submerged combustion melter 20, the molten glass M progresses through a finer 30 and a glass container forming machine 32. The finer 30 receives the molten glass M from the submerged combustion melter 20 and removes entrained gas bubbles from the molten glass M since the glass M leaving the melter 20 may contain 10 vol % to 60 vol % of gas bubbles. In one example, the finer 30 defines a channel through which the molten glass M flows while heat is introduced into the channel through wall mounted burners, thus allowing time for the entrained gas bubbles to escape from the molten glass M. After exiting the finer 30, the molten glass M is delivered to the glass container forming machine 32 either directly or through a forehearth (not shown) that thermally conditions the molten glass M (i.e., renders the molten glass M more thermally homogeneous and brings the glass M to a forming viscosity) if desired. The glass container forming machine 32 may include a blank mold 32a, which forms a charge of the molten glass M into a partially formed container or parison, and a blow mold 32b, which receives the parison from the blank mold 32a and expands the parison to form one of the glass containers 18. The glass container forming machine 32 may include multiple sections of blank and blow molds 32a, 32b.

To deliver the batch feed material 16 to the glass production line 12, the batch delivery system 14 includes a shared batch distribution unit 34 and a companion batch distribution unit 36 separate from the shared batch distribution unit 34 and dedicated to the glass production line 12. The shared batch distribution unit 34 combines a plurality of raw materials into a partial batch material 38 and supplies the partial batch material 38 to the companion batch distribution unit 36 and, thereafter, the batch feed material 16 is formed at the companion batch distribution unit 36 by adding a counterpart batch material 96 (FIG. 5) to the partial batch material 38. The batch feed material 16 is then delivered to the batch charger 28 of the submerged combustion melter 20. The plurality of raw materials contained in the partial batch material 38 preferably includes at least a first major raw material and a second major raw material selected from the following group of major raw materials: sand, soda ash, and limestone. At the companion batch distribution unit 36, a third major raw material, which is preferably the other of the raw materials from the aforementioned group not included in the partial batch material 38, is contained in the counterpart batch material 96 that is combined with the partial batch material 38. A fourth major raw material in the form of cullet may also optionally be added to the batch feed material 36 at the companion batch distribution unit 36. Moreover, any of a wide variety of minor raw materials may be included in the partial batch material 38 and/or the counterpart batch material 96.

Referring now more specifically to FIGS. 1-3, the shared batch distribution unit 34 includes a support frame 40 that is contained within an enclosure 42. The support frame 40 is supported by, and is anchored to, a slab 44 that provides a floor surface 46 and is preferably formed of concrete. The shared batch distribution unit 34 also includes a plurality of major material containers 48, which further include at least one first major material container 48a and at least one second major material container 48b. The major material containers 48 are carried by the support frame 40 in an elevated position above the floor surface 46 and are pneumatically fillable with their respective raw materials. Additionally, the shared batch distribution unit 34 may include at least one minor material container 50. The minor material container(s) 50 are also carried by the support frame 40 in an elevated position above the floor surface 46 and, as shown, may include one or more, and preferably a plurality of, standalone minor material containers 50a as well as one or more, and preferably a plurality of, colorant containers 50b that are grouped into a colorant module 52. These minor material containers 50 are also pneumatically fillable with their respective raw materials. Each of the major and minor material containers 48, 50 is preferably an elongated silo that includes a funnel portion, which defines an outlet, at its lower end. The enclosure 42 covers the support frame 40 and the major and minor material containers 48, 50 and establishes a working space 54 within which the major and minor material containers 48, 50 are maintained.

The first major material container(s) 48a store the first major raw material and the second major material container(s) 48b store the second major raw material. Again, here, and for the remainder of the description of the batch delivery system 14, the first, second, and third major raw materials are each selected from the group of sand (i.e., silica), soda ash (i.e., sodium carbonate), and limestone (i.e., calcium carbonate), while cullet is designated as the fourth major raw material. While the combination of raw materials included in the partial batch material 38 is subject to change, the partial batch material 38 delivered by the shared batch distribution unit 34 preferably includes soda ash as the first major raw material and limestone as the second major raw material while, as described in more detail below, the companion batch distribution unit 36 preferably adds sand as the third major raw material and optionally cullet as the fourth major raw material to the partial batch material 38. In that regard, each of the first major material container(s) 48a stores soda ash and each of the second major material container(s) 48b stores limestone. Because sand is the largest raw material of the batch feed material 16 by weight, storing and adding sand to the partial batch material 38 at the companion batch distribution unit 36 allows the shared batch distribution unit 34 to service multiple companion batch distribution units 36, if desired, while preserving a relatively small volumetric footprint.

Each of the minor material containers 50 stores a minor raw material. Any of a number of minor raw materials may be included in the partial batch material 38 to support the production of glass. A non-exhaustive listing of minor raw materials that may be stored in the minor material container(s) 50 includes, for example, (i) a sulfate-containing material such as salt cake (i.e., sodium sulfate), (ii) an alumina-containing material such as calcined alumina, aplite, nepheline syenite, dolomite, feldspar, and feldspatic sand, (iii) slag, (iv) pot ash, (v) sodium nitrate, (vi) carbon, and (vii) elemental or oxide forms of one or more of cobalt, selenium, nickel, copper, chromium, iron, manganese, arsenic, erbium, cerium, neodymium, gold, silver, and uranium. Each of the standalone minor material containers 50a may store a sulfate-containing material and, in particular, a sodium sulfate-containing material such as salt cake, or an alumina-containing material since those materials may be used regularly to prepare the partial batch material 38. Each of the colorant containers 50b in the colorant module 52 may store a minor material that serves as a colorant, which is a material that affects the color of the glass either alone or in combination with another material, including acting to decolor the glass to make the glass appear more colorless. Each of carbon and elemental or oxide forms of cobalt, selenium, nickel, copper, chromium, iron, manganese, arsenic, erbium, cerium, neodymium, gold, silver, and uranium may serve as colorants. Of course, many other materials may be used as minor materials despite not being explicitly mentioned above.

The partial batch material 38 may be formed at, and delivered from, the shared batch distribution unit 34 in any practical way. Here, for instance, and as shown in FIG. 3, an automated guided vehicle (“AGV”) 56 that carries a frame 58 having a scale 60, and that further carries a collection hopper 62 on the frame 58, travels along the floor surface 46 beneath the major and minor material containers 48, 50 and collects the raw materials that constitute the partial batch material 38. To help the collection hopper 62 receive raw materials from the containers 48, 50, each of the major material containers 48a, 48b and the standalone minor material containers 50a may include a docking station 64a, 64b, 66a supported on the lower end of the container 48a, 48b, 50a, and each of the colorant containers 50b may be coupled to a common dosing module 68. Each docking station 64a, 64b, 66a includes a housing that covers the container outlet, a movable docking shelf that is extendable from the housing, a material feeder such as a screw feeder within the housing to administer the corresponding raw material through the docking station 64a, 64b, 66a, a motor to drive the feeder, and a filter. The common dosing module 68 includes a canister having a scale and a movable docking shelf that is extendable from the housing, and each of the colorant containers 50b includes a housing that covers the container outlet, a conduit that connects the housing and the canister, and a material feeder such as a screw feeder within the housing to administer the corresponding raw material through the conduit to the canister. The scale in the common dosing module 68 may be a precision scale such as a cantilever bucket load cell. Some examples of docking stations and dosing modules that may be used here are described in further detail in International Pub. Nos. WO2022/072889 and WO2022/086698.

The AGV 56 moves the collection hopper sixty-two between the various major and minor material containers 48, 50 so that the raw materials needed to form the partial batch material 38 can be collected in the collection hopper 62. Specifically, the AGV 56 moves in a programed sequence to a location beneath each of the major material containers 48a, 48b and the standalone minor material containers 50a. At the location for each container 48a, 48b, 50a, the movable docking shelf of the docking station 64a, 64b, 66a, extends downward and registers with a guide ledge of the collection hopper 62, which engages a lever and opens one or more flaps that surround an inlet of the hopper 62 to establish a raw material flow path into the collection hopper 62 from the docking station 64a, 64b, 66a. The feeder then administers the corresponding raw material into the collection hopper 62, and the scale 60 determines when the appropriate amount of the raw material has been added. Once the raw material has been added, the docking shelf retracts from the guide ledge of the collection hopper and the flap(s) close the inlet of the hopper 62. This process is repeated at each of the major material containers 48a, 48b and the standalone minor material containers 50a. At the colorant module 52, each of the minor raw materials intended to be included in the partial batch material 38 is feed into the canister of the common dosing module 68 at the appropriate amount, as determined by the integrated scale, and the raw materials are then introduced into the collection hopper 62 after the docking shelf of the common dosing module registers with the guide ledge of the hopper 62. An example of an AGV and its operation that may be employed here are described in further detail in International Pub. No. WO2022/072893.

The shared batch delivery system 34 may also include a lifting and sending station 70 to transfer the partial batch material 38 from the collection hopper 62 and deliver the partial batch material 38 out of the shared batch distribution unit 34. The lifting and sending station 70 includes a hopper elevator 72 and a pneumatic sender 74. After the partial batch material 38 is compiled into the collection hopper 62, the AGV 56 moves to and arrives at the lifting and sending station 70. There, the hopper elevator 72 engages the collection hopper 62, retrieves the collection hopper 62 from the AGV 56 by lifting the collection hopper 62 off of the AGV 56, and sets the collection hopper 62 onto the pneumatic sender 74. Once the collection hopper 62 is set on the pneumatic sender 74, which is a pressurizable vessel, a bottom valve of the collection hopper 62 is opened, either by the action of setting the hopper 62 on the pneumatic sender 74 and/or by a separate action, to open an outlet of the collection hopper 62. The opening of the bottom valve empties the partial batch material 38 out of the collection hopper 62 and into the pneumatic sender 74. After the partial batch material 38 has been supplied to the pneumatic sender 74, the hopper elevator 72 lifts the empty collection hopper 62 off of the pneumatic sender 74 and returns it to the AGV 56 for another round of partial batch material collection. The pneumatic sender 74 is pressurized at any point after the empty collection hopper 62 is lifted away to pneumatically convey the partial batch material 38 to the companion batch distribution unit 36 through a pneumatic pipe 76. An example of a lifting and sending station that may be employed here is described in further detail in International Pub. No. WO/2022072900.

Referring now more specifically to FIGS. 1 and 4-5, the companion batch distribution unit 36 includes an enclosure 78 that houses one or more major material containers 80, which includes at least one third major material container 80a and optionally at least one fourth major material container 80b, and may further house at least one minor material container 82. Each of the major material container(s) 80 and the minor material container(s) 82 in the companion batch distribution unit 36 is preferably an elongated silo that includes a funnel portion, which defines an outlet, at its lower end. The third major material container(s) 80a stores the third major raw material, which is sand in the preferred implementation, and the fourth major material container(s) 80b, if present, stores the fourth major raw material, which, as indicated above, is cullet. Each of the minor material containers 82, as before, stores a minor raw material. Preferably, the minor material container(s) 82 within the companion batch distribution unit 36 store filter dust that is collected from the submerged combustion melter 20 of the glass production line 12 and returned to the container(s) 82. As such, in the preferred implementation, the first major material container(s) 48a and the second major material container(s) 48b in the shared batch distribution unit 34 store soda ash and limestone, respectively, the third major material container(s) 80a and the fourth major material container(s) 80b in the companion batch distribution unit 36 store sand and cullet, respectively, and the minor material container(s) 50, 82 may store the minor raw materials specified in Table 1 below.

TABLE 1
PREFERRED RAW MATERIAL STORAGE
IN BATCH DELIVERY SYSTEM

| | |
|---|---|
| Container | Raw Material |

SHARED BATCH DISTRIBUTION UNIT
(Partial Batch Material)

| | |
|---|---|
| First Major | Soda Ash |
| Material Container | |
| Second Major | Limestone |
| Material Container | |
| Standalone Minor | Sulfate-Containing Material |
| Material Container | (e.g., sodium sulfate) |
| Standalone Minor | Alumina-Containing Material (e.g., calcined |
| Material Container | alumina, aplite nepheline syenite, feldspar, |
| | feldspatic sand) |
| Standalone Minor | Alumina-Containing Material (e.g., calcined |
| Material Container | alumina, aplite nepheline syenite, feldspar, |
| | feldspatic sand) |
| Colorant Container | Colorant Material (e.g., carbon, elemental |
| | or oxide forms of cobalt, selenium, nickel, |
| | copper, chromium, iron, manganese, arsenic, |
| | erbium, cerium, neodymium, gold, silver, and |
| | uranium) |
| Colorant Container | Colorant Material (e.g., carbon, elemental |
| | or oxide forms of cobalt, selenium, nickel, |
| | copper, chromium, iron, manganese, arsenic, |
| | erbium, cerium, neodymium, gold, silver, and |
| | uranium) |
| Colorant Container | Colorant Material (e.g., carbon, elemental |
| | or oxide forms of cobalt, selenium, nickel, |
| | copper, chromium, iron, manganese, arsenic, |
| | erbium, cerium, neodymium, gold, silver, and |
| | uranium) |

COMPANION BATCH DISTRIBUTION UNIT
(Counterpart Batch Material)

| | |
|---|---|
| Third Major | Sand |
| Material Container | |
| Fourth Major | Cullet |
| Material Container | |
| Fourth Major | Cullet |
| Material Container | |
| Fourth Major | Cullet |
| Material Container | |
| Fourth Major | Cullet |
| Material Container | |
| Minor Material | Filter Dust |
| Container | |

In the preferred implementation shown here, the companion batch distribution unit 36 includes a single third major material container 80a that stores sand and a plurality of fourth major material containers 80b that store cullet. Multiple fourth major material containers 80b are included in the companion batch distribution unit 36 so that cullet sourced from different providers can be stored separately. This allows for more flexibility in cullet management. For example, due the wide variability in available cullet, including differences in impurities, cullet from one source may be added to the batch feed material 16 when making flint glass as well as other colors of glass due to its low iron content while, conversely, cullet from another source may have an iron content that is too high for making flint glass but is otherwise suitable for making other colors of glass. By storing cullet from different sources in different fourth major material containers 80b, it is possible to mix cullet from one fourth major material container 80b with cullet from at least one other fourth major material container 80b to produce a cullet mixture that is usable for the particular color of glass being made, including flint glass, even though the cullet contributed from one of the containers 80b would not be suitable on its own. Moreover, to simplify loading, each of the third and fourth major material containers 80a, 80b is filled by a bucket elevator 84a, 84b that delivers the corresponding raw material from a third raw material unloading pit 86a and fourth raw material unloading pit 86b, respectively. This is helpful for cullet given its crushed nature and allows either wet or dry sand to be loaded into the third major material container(s) 80a.

The batch feed material 16 may be formed at, and delivered from, the companion batch distribution unit 36 in any practical way. Here, the companion batch distribution unit 36 includes a pneumatic receiver 88, a scale 90, a mixer 92, and a batch conveyor 94. The pneumatic receiver 88, which is a vessel, receives the partial batch material 38 from the pneumatic pipe 76 and stores the partial batch material 38 for any period of time. The scale 90 is disposed beneath the third major material container(s) 80a and the minor material container(s) 82 and is configured to receive the third major raw material (preferably sand) from the third major material containers 80a and the minor raw material(s) (preferably filter dust), if provided, from the minor material container(s) 82 to provide the counterpart batch material 96. The scale 90 weighs the third major raw material and the minor raw material(s) to ensure the correct amount of those raw materials are ultimately included in the batch feed material 16. The scale 90 may be a digital static scale so that it can accurately weigh the minor raw material(s) within the counterpart batch material 96 since the minor raw material(s) typically have to be weighed more precisely than the third major raw material. The mixer 92 is configured to receive the partial batch material 38 from the pneumatic receiver 88 and the counterpart batch material 96 from the scale 90. Both the pneumatic receiver 88 and the scale 90 may be emptied into the mixer 92 by opening a valve and allowing the materials to flow by gravity into the mixer 92. The mixer 92 is preferably a pan-style mixer that includes a rotatable central hub and mixing paddles, spokes, blades, or other appendices that extend outwardly from the hub. One example of a pan-style mixer is a pan planetary mixer.

The mixing of the partial batch material 38 and the counterpart batch material 96 in the mixer 92 establishes the batch feed material 16 since the first, second, and third major raw materials are now present together. The batch feed material 16 is then discharged from the mixer 92 onto the batch conveyor 94 and conveyed away from the mixer 92. If cullet is to be added to the batch feed material 16 as a fourth major raw material, which is provided for in the preferred implementation of the companion batch distribution unit 36, cullet from one or more of the fourth major material containers 80b is added to the batch feed material 16 as the batch feed material 16 is conveyed along the batch conveyor 94. For instance, as shown best in FIG. 5, a weigh belt 98 is disposed beneath the outlet of each of the fourth major material containers 80b, and, as such, cullet from any one or more of the fourth major material containers 80b may be discharged onto its associated weigh belt 98 and the intended amount of cullet from each container 80b may then be distributed onto the batch feed material 16 as the batch feed material 16 is conveyed on the batch conveyor 94 below the weigh belt(s) 98. Following the addition of cullet, if applicable, the batch feed material 16 is conveyed to a bucket elevator 100 that transfers the batch feed material 16 to a melter day bin 102, which may be located inside or outside of the enclosure 78. The melter day bin 102 stores a certain amount of the batch feed material 16 such as, for example, enough material to feed the submerged combustion melter 20 for several hours, and supplies the batch feed material 16 to the batch charger 28.

The companion batch distribution unit 36 may include additional devices to help manage the batch feed material 16. For instance, in the preferred implementation shown here, the companion batch distribution unit 36 may include a batch composition analyzer 104, a magnet 106, a metal detector 108, and a batch rejection diverter 110. The batch composition analyzer 104 is stationed above the batch conveyor 94 between the mixer 92 and the fourth major material containers 80b so that the batch composition analyzer 104 can analyze the batch composition of the batch feed material 16 prior to any cullet being added. The batch composition analyzer 104 may be any analytical device that can indicate whether the amount of each raw material included in the batch feed material 16 is present within a specified target range. Examples of analytical devices that may be employed as the batch composition analyzer 104 include a LIBS (laser induced breakdown spectroscopy) system and a Raman spectroscopy system. The magnet 106 may be stationed above the batch conveyor 94 after the fourth major material containers 80b to remove metal from the cullet added to the batch material 16. The metal detector 108 may be stationed above the batch conveyor 94 after the magnet 106 to detect whether the cullet added to the batch feed material 16 contains any metal. The metal detector 108 may be any commercially available metal detector and, preferably, can detect the presence of both ferrous and non-ferrous metals.

The batch rejection diverter 110 may be positioned adjacent to the batch conveyor 94 after the batch composition analyzer 104 and the metal detector 108 (if present). The batch rejection diverter 110 is movable from a stowed position to a reject position. In the stowed position, the batch rejection diverter 110 does not impede the transfer of the batch feed material 16 along the batch conveyor 94. In contrast, when the batch rejection diverter 110 is in the reject position, the diverter 110 blocks the transfer of the batch feed material 16 to the bucket elevator 100 associated with the melter day bin 102 and, instead, diverts the batch feed material 16 into a rejection bin such as a dumpster. The batch rejection diverter 110 may be an actuatable flap that is manually actuatable or automatically actuatable based on programmed instructions. The batch feed material 16 may be rejected and diverted into the rejection bin, for example, if the batch composition analyzer 104 indicates that the batch composition of the batch feed material 16 does not meet a batch composition specification because at least one raw material of the batch feed material 16 is present in an amount that falls outside its specified target range and/or if the metal detector 108 detects the presence of metal above a specified metal material limit. The batch rejection diverter 110 may be maintained at the reject position for a defined period of time or until the batch composition analyzer 104 indicates that each raw material of the batch feed material 16 is present in an amount that falls within its specified target range and the metal detector 108 detects that the amount of metal present in the batch feed material 16 is less than the specified metal material limit.

A scaled up or expanded version of the batch delivery system is shown in FIGS. 6-9 and is identified by reference numeral 1014. In FIGS. 6-9, structural features and other elements that are the same or similar to those shown in FIGS. 1-5 are identified with corresponding “1000-series” reference numerals. For any such structural features and elements in FIGS. 6-8 that are designated with a corresponding 1000-series reference numeral, the descriptions of the corresponding features/elements set forth above with respect to the batch delivery system 14 shown in FIGS. 1-5 apply equally to the batch delivery system 1014 shown here unless stated otherwise. The applicable descriptions will thus not be repeated here, although they are understood to apply as if fully restated in their entireties, and, instead, only the main differences between the batch delivery systems 14, 1014 will be described in further detail. The batch delivery system 1014 as depicted in FIGS. 6-8 has been expanded from the system 14 depicted in FIGS. 1-5 to provide an increased output capacity to accommodate additional glass production lines 1012 that have been added to the glass manufacturing plant 1010. These additional glass production lines 1012 have been added to increase the glass capacity of the glass manufacturing plant 1010 and/or to add glass container production flexibility to the plant 1010.

The glass manufacturing plant 1010 includes a first glass production line 1012A, a second glass production line 1012B, and a third glass production line 1012C. The first glass production line 1012A is the original glass production line 12 of the plant 10 described above while the second and third glass production lines 1012B, 1012C have been added to the plant 1010. The first glass production line 1012A is the same as the glass production line 12 described above and each of the second and third glass production lines 1012B, 1012C are the same as the first glass production line 1012A. Notably, the first, second, and third glass production lines 1012A, 1012B, 1012C include a first, second, and third submerged combustion melter 1020A, 1020B, 1020C, respectively, that receive a corresponding first, second, and third batch feed material 1016A, 1016B, 1016C for melting into molten glass M_{A}, M_{B}, M_{C}. To service the plurality of glass production lines 1012A, 1012B, 1012C, the batch delivery system 1014 includes a shared batch distribution unit 1034 as well as a first companion batch distribution unit 1036A that receives a first partial batch material 1038A, a second companion batch distribution unit 1036B that receives a second partial batch material 1038B, and a third companion batch distribution unit 1036C that receives a third partial batch material 1038C. The shared batch distribution unit 1034 is similar to the shared batch distribution unit 34 described above although it is expanded to support the multiple companion batch distribution units 1036A, 1036B, 1036C.

The expanded shared batch distribution unit 1034 includes a support frame 1040 that is contained within an enclosure 1042, as explained above, and also includes a plurality of major material containers 1048, which further include at least one first major material container 1048a and at least one second major material container 1048b, and may additionally have at least one minor material container 1050. The minor material container(s) 1050 may include one or more, and preferably a plurality of, standalone minor materials containers 1050a as well as one or more, and preferably a plurality of, colorant containers 1050b that are grouped into a colorant module 1052. Here, the expanded shared batch distribution unit 1034 preferably includes two of the first major material containers 1048a and one of the second major material containers 1048b to help ensure that the shared batch distribution unit 1034 has enough major raw materials to serve the multiple batch distribution units 1036A, 1036B, 1036C. The two first major material containers 1048a may store soda ash—the additional first major material container 1048a that is added may simply be connected to the support frame 1040 similar to the others—and the second major material container 1048b may store limestone. Moreover, the expanded shared batch distribution system 1034 may include a first set of colorant containers 1050b grouped into a first colorant module 1052-1 and a second set of colorant containers 1050b grouped into a second colorant module 1052-2. The inclusion of at two colorant modules 1052-1, 1052-2 allows the expanded shared batch distribution unit 1034 to support the production of different colors of glass at the same time.

To deliver the first, second, and third partial batch materials 1038A, 1038B, 1038C to the corresponding first, second, and third companion batch distribution units 1036A, 1036B, 1036C, the shared batch delivery system 1034 may include a first lifting and sending station 1070A, a second lifting and sending station 1070B, and a third lifting and sending station 1070C. In that regard, a plurality of AGVs 1056 (FIG. 8), each carrying a collection hopper 1062, may operate simultaneously within the expanded shared batch distribution unit 1034 to collect and supply first, second, and third partial batch material 1038A, 1038B, 1038C to the corresponding first, second, and third lifting and sending stations 1070A, 1070B, 1070C. The first lifting and sending station 1070A delivers the first partial batch material 1038A to the first companion batch distribution unit 1036A, the second lifting and sending station 1070B delivers the second partial batch material 1038A to the second companion batch distribution unit 1036B, and the third lifting and sending station 1070C delivers the third partial batch material 1038C to the third companion batch distribution unit 1036C. Specifically, in each instance, the partial batch material 1038A, 1038B, 1038C may be pneumatically conveyed from the pneumatic sender 1074A, 1074B, 1074C to the pneumatic receiver 1088A, 1088B, 1088C of the corresponding companion batch distribution unit 1036A, 1036B, 1036C through the pneumatic pipe 1076A, 1076B, 1076C.

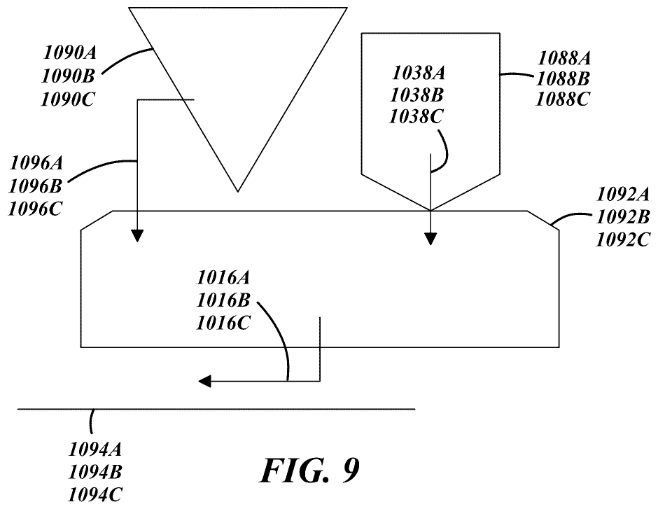

The companion batch distribution units 1036A, 1036B, 1036C are the same as described above. Each of the first, second, and third companion batch distribution units 1036A, 1036B, 1036C receives its respective first, second, and third partial batch material 1038A, 1038B, 1038C from the shared batch distribution unit 1034 as described above, for example. The first, second, and third batch feed materials 1016A, 1016B, 1016C are then formed at the first, second, and third companion batch distribution units 1036A, 1036B, 1036C, respectively, by combining a first counterpart batch material 1096A with the first partial batch material 1038A, a second counterpart batch material 1096B with the second partial batch material 1038B, and a third counterpart batch material 1096C with the third partial batch material 1038C, as shown in the representative schematic of FIG. 9. The first, second, and third batch feed materials 1016A, 1016B, 1016C, once formed, are delivered, respectively, to the first, second, and third submerged combustion melters 1020A, 1020B, 1020C of their associated glass production lines 1012A, 1012B, 1012C through a batch charger 1028A, 1028B, 1028C. Accordingly, the shared batch distribution unit 1034, in an expanded form as shown here, may deliver the partial batch materials 1038A, 1038B, 1038C to the multiple companion batch distribution units 1036A, 1036B, 1036C at the same time in the same fashion and just as easily as it could service a single companion batch distribution unit, as shown in FIGS. 1-5.

The first, second, and third batch feed materials 1016A, 1016B, 1016C delivered by batch delivery system 1014 may be the same or different depending on the operating requirements of the glass production lines 1012A, 1012B, 1012C. The difference in the batch feed materials 1016A, 1016B, 1016C may relate to batch composition, mass flow rate (weight/time), batch weight, or some other distinction. In one operating scenario, one of the first, second, or third batch feed materials 1016A, 1016B, 1016C may have a batch composition that corresponds to one color of glass and another of the first, second, or third batch feed materials 1016A, 1016B, 1016C may have a batch composition that corresponds to another color of glass. For example, one of the batch feed materials 1016A, 1016B, 1016C may have a batch composition that corresponds to flint glass while another of the batch feed materials 1016A, 1016B, 1016C may have a batch composition that corresponds to a green or amber glass. The batch compositions for flint, green, and amber glasses, as well as other colors, can be achieved through certain combinations of raw materials including certain applicable colorant materials. In another operating scenario, one of the first, second, or third batch feed materials 1016A, 1016B, 1016C may have a mass flow rate out of its respective companion batch distribution unit 1036A, 1036B 1036C and another of the first, second, or third batch feed materials 1016A, 1016B, 1016C may have another, different mass flow rate out of its respective companion batch distribution unit 1036A, 1036B 1036C. Such differences in mass flow rates may support the production of different glass articles and/or different glass production rates.

The subject matter of this application is presently disclosed in conjunction with several illustrative embodiments and modifications to those embodiments. All terms used herein are intended to be merely descriptive, rather than necessarily limiting, and are to be interpreted and construed in accordance with their ordinary and customary meaning in the art, unless used in a context that requires a different interpretation. As such, many other embodiments, modifications, and equivalents thereto will readily be suggested to persons of ordinary skill in the art in view of the present disclosure and all such variations, even though not necessarily explicitly disclosed, that fall within the scope of the accompanying claims are intended to be embraced by the present disclosure.

1. A batch delivery system, comprising:
a shared batch distribution unit that delivers a partial batch material; and
a companion batch distribution unit, which is separate from the shared batch distribution unit, that receives the partial batch material, and, wherein, at the companion batch distribution unit, the partial batch material is combined with a counterpart batch material to form a batch feed material that is meltable into molten glass.

2. The batch delivery system set forth in claim 1, wherein the batch feed material comprises a first major raw material, a second major raw material, and a third major raw material, and wherein the partial batch material comprises at least the first major raw material and the second major raw material, and the counterpart batch material comprises at least the third major raw material.

3. The batch delivery system set forth in claim 2, wherein the first major raw material is soda ash, the second major raw material is limestone, and the third major raw material is sand.

4. The batch delivery system set forth in claim 2, wherein the shared batch distribution unit comprises at least one first major material container that stores the first major raw material and at least one second major material container that stores the second major raw material, and wherein the companion batch distribution unit comprises at least one third major material container that stores the third major raw material.

5. The batch delivery system set forth in claim 2, wherein the partial batch material further comprises at least one minor raw material.

6. The batch delivery system set forth in claim 5, wherein the at least one minor raw material is at least one of (i) a sulfate-containing material, (ii) an alumina-containing material, (iii) slag, (iv) pot ash, (v) sodium nitrate, or (vi) a colorant.

7. The batch delivery system set forth in claim 6, wherein the sulfate-containing material includes salt cake, the alumina-containing material includes at least one of calcined alumina, aplite, nepheline syenite, dolomite, feldspar, or feldspatic sand, and the colorant includes at least one of carbon or elemental or oxide forms of one or more of cobalt, selenium, nickel, copper, chromium, iron, manganese, arsenic, erbium, neodymium, gold, silver, and uranium.

8. The batch delivery system set forth in claim 6, wherein the shared batch distribution unit further comprises at least one standalone minor material container that stores one of the sulfate-containing material, the alumina-containing material, slag, potash, or sodium nitrate.

9. The batch delivery system set forth in claim 6, wherein the shared batch distribution unit further comprises a colorant module that includes a plurality of colorant containers, each of the colorant containers storing a colorant.

10. The batch delivery system set forth in claim 2, wherein the batch feed material includes a fourth major raw material, which is cullet, and the fourth major raw material is added to the batch feed material at the companion batch distribution unit.

11. The batch delivery system set forth in claim 10, wherein the companion batch distribution unit comprises at least one fourth major material container that stores the fourth major raw material.

12. The batch delivery system set forth in claim 10, wherein the companion batch distribution unit further comprises a batch analyzer that analyzes a batch composition of the batch feed material prior to the fourth major raw material being added to the batch feed material.

13. The batch delivery system set forth in claim 10, wherein the companion batch distribution unit further comprises:
a magnet stationed to remove metal from the fourth major raw material after the fourth major raw material has been added to the batch feed material; and
a metal detector stationed after the magnet to detect whether the fourth major raw material added to the batch feed material contains any metal.

14. The batch delivery system set forth in claim 1, wherein the partial batch material is pneumatically conveyed to the companion batch distribution unit.

15. The batch delivery system set forth in claim 1, wherein the companion batch distribution unit includes a pneumatic receiver that receives the partial batch feed material from the shared batch distribution unit, a scale that provides the counterpart batch material, and a mixer that receives the partial batch feed material from the pneumatic receiver and the counterpart batch material from the scale and mixes the partial batch material and the counterpart batch material together to form the batch feed material.

16. The batch delivery system set forth in claim 15, wherein the companion batch distribution unit further comprises a batch conveyor onto which the batch feed material is discharged from the mixer.

17. The batch delivery system set forth in claim 1, wherein the companion batch distribution unit further comprises a batch rejection diverter that is movable to divert the batch feed material to a rejection bin.

18. The batch delivery system set forth in claim 1, wherein the batch feed material is a first batch feed material, the partial batch material is a first partial batch material, the counterpart batch material is a first counterpart batch material, and the companion batch distribution unit is a first companion batch distribution unit that receives the first partial batch material from the shared batch distribution unit and combines the first partial batch material with the first counterpart batch material to form the first batch feed material, and wherein the batch delivery system further comprises:
a second companion batch distribution unit, which is separate from the shared batch distribution unit, that receives a second partial batch material from the shared batch distribution unit, and, wherein, at the second companion batch distribution unit, the second partial batch material is combined with a second counterpart batch material to form a second batch feed material that is meltable into molten glass.

19. The batch delivery system set forth in claim 18, wherein the first batch feed material formed at the first companion batch distribution unit has a batch composition that corresponds to one color of glass and the second batch feed material formed at the second companion batch distribution unit has a batch composition that corresponds to another color of glass.

20. The batch delivery system set forth in claim 18, wherein a mass flow rate of the first batch feed material out of the first companion batch distribution unit is different from a mass flow rate of the second batch feed material out of the second companion batch distribution unit.

21. A glass manufacturing plant, comprising:
a glass production line; and
the batch delivery system set forth in claim 1.

22. The glass manufacturing plant set forth in claim 21, wherein the glass production line comprises a submerged combustion melter, and wherein the batch feed material is delivered to, and melted in, the submerged combustion melter.

23. The glass manufacturing plant set forth in claim 21, wherein the glass production line comprises a glass container forming machine that receives a charge of molten glass and forms the charge of molten glass into a glass container.

24. A method comprising:
forming a partial batch material at a shared batch distribution unit;
delivering the partial batch material to a companion batch distribution unit;
combining the partial batch material and a counterpart batch material to form a batch feed material at the companion batch distribution unit; and
delivering the batch feed material to a glass production line; and
melting the batch feed material in the glass production line to produce molten glass.

25. The method set forth in claim 24, wherein the batch feed material produced by combining the partial batch material and the counterpart batch material comprises a first major raw material, a second major raw material, and a third major raw material.

26. The method set forth in claim 25, wherein forming the partial batch material comprises combining a plurality of raw materials together to form the partial batch material, the plurality of raw materials including at least the first major raw material and the second major raw material, and wherein the counterpart batch material includes at least the third major raw material.

27. The method set forth in claim 26, wherein the plurality of raw materials further includes at least one minor raw material.

28. The method set forth in claim 27, wherein the at least one minor raw material is at least one of (i) a sulfate-containing material, (ii) an alumina-containing material, (iii) slag, (iv) pot ash, (v) sodium nitrate, or (vi) a colorant.

29. The method set forth in claim 25, wherein combining the partial batch material and the counterpart batch material to form the batch feed material comprises:
receiving the third major raw material and any other raw materials included in the counterpart batch material onto a scale to weigh the counterpart batch material;
receiving the partial batch material into a mixer and receiving the counterpart batch material into the mixer from the scale; and
mixing the partial batch material and the counterpart batch material together.

30. The method set forth in claim 25, wherein the first major raw material is soda ash, the second major raw material is limestone, and the third major raw material is sand.

31. The method set forth in claim 25, further comprising:
adding a fourth major raw material, which is cullet, to the batch feed material at the companion batch distribution unit.

32. The method set forth in claim 31, further comprising:
analyzing a batch composition of the batch feed material before the fourth major raw material is added to the batch feed material;
removing metal from the fourth major raw material that has been added to the batch feed material; and
detecting whether the fourth major raw material that has been added to the batch feed material contains any metal after removing metal from the fourth major raw material.

33. The method set forth in claim 32, further comprising:
blocking the batch feed material from being delivered to the glass production line if either (i) the batch composition of the batch feed material does not meet a batch composition specification or (ii) metal is detected in an amount that is above a specified metal material limit.

34. The method set forth in claim 24, wherein delivering the batch feed material to the glass production line comprises:
discharging the batch feed material onto a batch conveyor;
transferring the batch feed material to a day bin to store the batch feed material; and
supplying the batch feed material from the day bin to the glass production line.

35. The method set forth in claim 24, wherein delivering the partial batch material to the companion batch distribution unit comprises pneumatically conveying the partial batch material from a pneumatic sender at the shared batch distribution unit to a pneumatic receiver in the companion batch distribution unit.

36. The method set forth in claim 24, comprising:
forming a first partial batch material at the shared batch distribution unit;
forming a second partial batch material at the shared batch distribution unit;
delivering the first partial batch material to a first companion batch distribution unit;
delivering the second partial batch material to a second companion batch distribution unit;
combining the first partial batch material and a first counterpart batch material to form a first batch feed material at the first companion batch distribution unit;
combining the second partial batch material and a second counterpart batch material to form a second batch feed material at the second companion batch distribution unit;
delivering the first batch feed material to a first glass production line and melting the first batch feed material in the first glass production line to produce molten glass; and
delivering the second batch feed material to a second glass production line and melting the second batch feed material in the second glass production line to produce molten glass.

37. The method set forth in claim 36, wherein the first batch feed material delivered from the first companion batch distribution unit to the first glass production line has a batch composition that corresponds to one color of glass and the second batch feed material delivered from the second companion batch distribution unit to the second glass production line has a batch composition that corresponds to another color of glass.

38. The method set forth in claim 36, wherein the first batch feed material is delivered from the first companion batch distribution unit at a mass flow rate and the second batch feed material is delivered from the second companion batch distribution unit at another, different mass flow rate.
